(19) United States
(12) Patent Application Publication
(10) Pub. No.: US 2023/0320345 A1
(43) Pub. Date: Oct. 12, 2023

(54) METHODS AND COMPOSITIONS FOR INHIBITING ICE RECRYSTALLIZATION

(71) Applicant: UNIVERSITY OF TENNESSEE RESEARCH FOUNDATION, Knoxville, TN (US)

(72) Inventor: Tao Wu, Farragut, TN (US)

(73) Assignee: UNIVERSITY OF TENNESSEE RESEARCH FOUNDATION, Knoxville, TN (US)

(21) Appl. No.: 18/124,110

(22) Filed: Mar. 21, 2023

Related U.S. Application Data
(60) Provisional application No. 63/269,918, filed on Mar. 25, 2022.

(51) Int. Cl. A01N 1/02

(52) U.S. Cl. CPC A01N 1/0221; A01N 1/0284

(57) ABSTRACT

A method for inhibiting ice recrystallization in a cryogenic medium is provided. The method includes the steps of cryopreserving a biological substrate including at least one of cryopreserved biological cells, cryopreserved biological tissue, and cryopreserved biological organs; and applying a bile salt to the cryopreserved biological substrate before and/or during cryopreservation of the biological substrate. A corresponding stabilized cryopreserved medium is also provided.

### RELATED APPLICATIONS

This application claims the benefit of U.S. Provisional Application No. 63/269,918, filed Mar. 25, 2022, the entirety of which is incorporated herein by reference.

### STATEMENT REGARDING FEDERALLY SPONSORED RESEARCH

This invention was made with government support under grant number 2019-06761, awarded by the United States Department of Agriculture. The government has certain rights in the invention.

### COLOR DRAWINGS

The patent or application file contains color drawings. Copies of this patent or patent application publication with color drawing(s) will be provided by the Office upon request and payment of the necessary fee.

### TECHNICAL FIELD

This application relates to the development and use of one class of small biological molecules, namely bile salts, as ice recrystallization inhibitors.

### BACKGROUND

Ice recrystallization inhibitors are novel cryoprotective agents that can reduce the freezing damage of cells, tissues, and organs in cryopreservation. To date, ice recrystallization inhibition (IRI) activity has been found on antifreeze (glyco) proteins, polymers, nanomaterials, and a limited number of chemically synthesized small molecules..

The long-term storage of cells, tissues, and organs in biotechnology and biomedicine usually relies on a cryopreservation process, where the formation and recrystallization of ice crystals result in cell damage. Ice formation decreases the unfrozen phase volume of the cells, tissues and organs and increases solute concentration, leading to osmotic stress that damages cells. Ice recrystallization is a thermodynamically favored process characterized as the growth of large ice crystals at the expense of small ice crystals, and also results in cell damage. Therefore, the addition of cryoprotectants, such as dimethyl sulfoxide (DMSO) and glycerol, is often practiced to minimize cell damage. However, DMSO and glycerol are commonly used at high concentrations and must be removed before many applications. For example, 40% w/v glycerol is used in the cryopreservation of red blood cells and a time-consuming post-thaw washing is necessary to reduce the glycerol content to less than 1% before performing a blood transfusion. Recently ice recrystallization inhibitors have been studied as novel cryoprotective agents to avoid this post-thaw washing step.

Various winter-tolerant organisms produce antifreeze proteins (AFPs) and antifreeze glycoproteins (AFGPs), which are potent ice recrystallization inhibitors. However, the practical application of AF(G)Ps has been hindered by their low availability and high production cost. Therefore, many efforts have been dedicated to developing low-cost synthetic materials as AF(G)Ps mimics, including small molecules, polymers, and nanomaterials. Among them, small molecules are attractive due to their ability to permeate cells and penetrate tissues, thus inhibiting ice recrystallization inside cells and in the interior region of tissues, which are significant concerns in cryopreservation.

Inspired by the repeating tripeptide structure of L-threonyl-L-alanyl-L-alanyl where the L-threonyl side chain is glycosylated with a disaccharide β-D-galactosyl-(1,4)-α-D-N-acetyl galactosamine in AFGPs, several AFGP analogs with a C-linked β-D-galactose residue have been synthesized, and their IRI activity was studied as functions of the glycoprotein length and the distance between carbohydrate moiety and polypeptide backbone. Additionally, C-linked AFGP analogs with D-galactose, D-glucose, D-mannose, and D-talose residues have synthesized, and the importance of hydration for their IRI activity was noted. Another study confirmed the role of hydration in the IRI activity of mono- and disaccharides. Potent IRI activity was found on several low molecular weight carbohydrate-based surfactants and hydrogelators. In addition, the importance of hydrophobic moieties for potent IRI activity has been recognized on lysine-based surfactants/gelators. Since then, a new group of ice recrystallization inhibitors with the long alkyl group replaced by an aryl ring were synthesized. Other cryopreservation studies indicate that these small molecular ice recrystallization inhibitors possess cell-penetrating capabilities and cryoprotecting effects toward various types of cells.

A facial amphiphilicity with segregated hydrophilic and hydrophobic groups has been proposed as a key motif for the antifreeze activity of AFGPs. The association between amphiphilicity and IRI activity has been confirmed in several IRI active materials, including nisin, zirconium acetate, and zirconium acetate hydroxide, amphiphilic metallohelices, glycopolymers with facial amphiphilicity, an amphiphilic fiber self-assembled from a synthetic dye, and naturally occurring amphiphilic nanocelluloses.

### SUMMARY

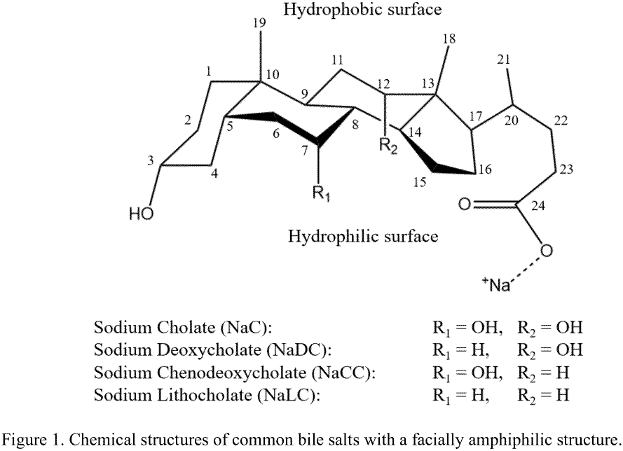

The present disclosure is directed to the use of bile salts and compositions containing bile salts as ice recrystallization inhibitors. Bile salts are small molecule biosurfactants synthesized in mammals to facilitate the digestion of lipids. As shown in FIG. 1, bile salts contain a steroid backbone with a carboxylate group linked to C24, and up to three hydroxyl groups on C3, C7 and C12. The steroid skeleton has a saucer shape in which all hydroxyl groups point to a concave surface.

It has been discovered that the IRI activity of bile salts increases as the number of hydroxyl groups decreases. Representative bile salts include sodium cholate (NaC), sodium deoxycholate (NaDC), sodium chenodeoxycholate (NaCC), and sodium lithocholate (NaLC). Among these, NaLC is the least hydrophilic and, at selected concentrations, can completely block the ice growth in phosphate-buffered saline (PBS) under test conditions. Bile salts have a facial amphiphilicity and might possess IRI activity based on the association between amphiphilicity and IRI.

Previously, only a limited number of small molecules were found to possess IRI activity, and all of them were obtained by chemical synthesis. The present disclosure is believed to represent the first discovery of IRI activity in small biological molecules and, in particular, bile salts.

With the foregoing in mind, it is a feature and advantage of this disclosure to provide a method of inhibiting ice recrystallization in a cryopreserved biological medium. The method includes the steps of:
cryopreserving a biological substrate including at least one of cryopreserved biological cells, cryopreserved biological tissue, and cryopreserved biological organs; and
applying a bile salt to the cryopreserved biological substrate before and/or during cryopreservation of the biological substrate.

In another embodiment, it is a feature and advantage of the disclosure to provide a method of inhibiting ice recrystallization in a cryopreserved biological medium, which includes the following steps:
cryopreserving a biological substrate including at least one of cryopreserved biological cells, cryopreserved biological tissue, and cryopreserved biological organs; and
applying a solution containing a bile salt to the cryopreserved biological substrate before and/or during cryopreservation of the biological substrate
wherein the solution includes about 25 mM to about 100 mM of the bile salt in an organic solvent.

In another embodiment, it is a feature and advantage of the disclosure to provide a stabilized cryopreserved biological medium, including the following elements:
a cryopreserved biological substrate including at least one of biological cells, biological tissue, and biological organs; and
a bile salt coated onto the cryopreserved biological substrate;
wherein the bile salt inhibits ice recrystallization on the cryopreserved biological substrate.

The foregoing and other features and advantages will become apparent from the following detailed description, read in conjunction with the accompanying figures and claims.

### BRIEF DESCRIPTION OF THE DRAWINGS

FIG. 1 shows the chemical structures of bile salts having a facially amphiphilic structure.

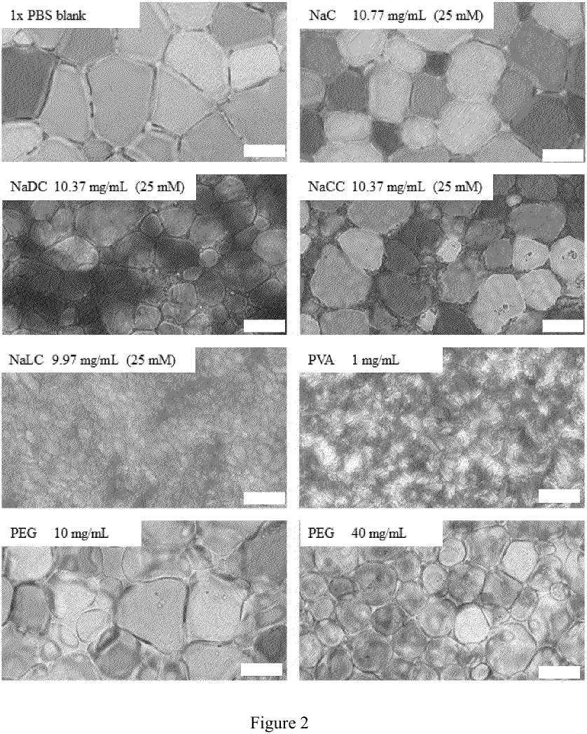

FIG. 2 is a color drawing showing representative ice wafer images for slides treated with sodium cholate (NaC), sodium deoxycholate (NaDC), sodium chenodeoxycholate (NaCC), and sodium lithocholate (NaLC), with polyethylene glycol (PEG) and polyvinyl alcohol (PVA) used as a negative and positive control, respectively. The media was 1x PBS. Images were collected after 30 min of incubation at -8° C. (Scale bar = 100 µm).

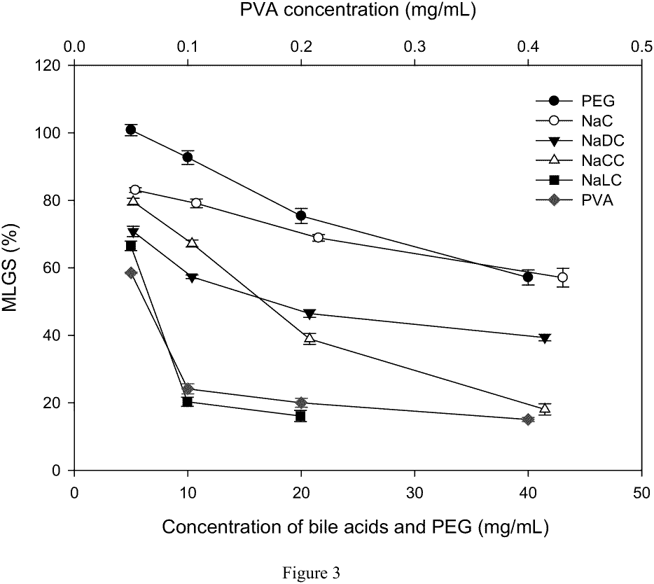

FIG. 3 is a color graph showing percentages of mean largest grain size (%MLGS) as a function of concentration for ice wafers in the presence of sodium cholate (NaC), sodium deoxycholate (NaDC), sodium chenodeoxycholate (NaCC), and sodium lithocholate (NaLC) in 1x PBS at 12.5, 25, 50, and 100 mM and presented mg/mL, with polyethylene glycol (PEG) as a negative control and polyvinyl alcohol (PVA) as a positive control. PVA concentrations are shown on the top x-axis. A lower %MLGS represents a higher IRI activity.

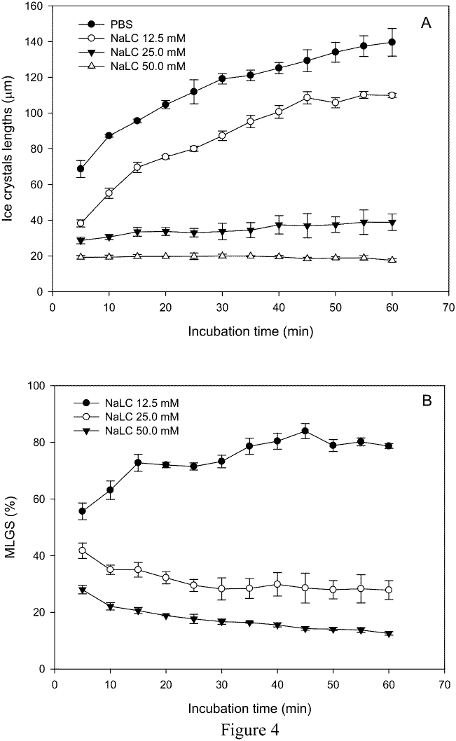

FIG. 4 includes two graphs showing ice crystal length as a function of incubation time, and %MLGS as a function of incubation time at -8° C., for ice wafers in the presence of NaLC in PBS at concentrations of 12.5 mM, 25.0 mM, and 50.0 mM, with PBS used as a control.

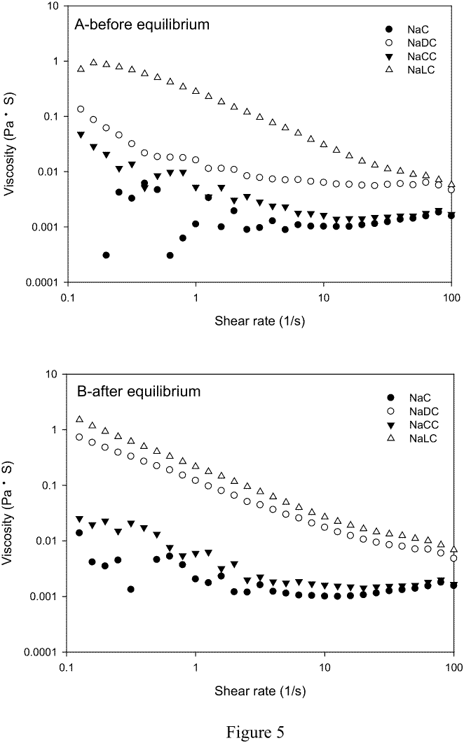

FIG. 5 includes two graphs showing the viscosity profiles of sodium cholate (NaC), sodium deoxycholate (NaDC), sodium chenodeoxycholate (NaCC), and sodium lithocholate (NaLC) at 25 mM in 1x PBS before (A) and after equilibrium (B) for 30 min.

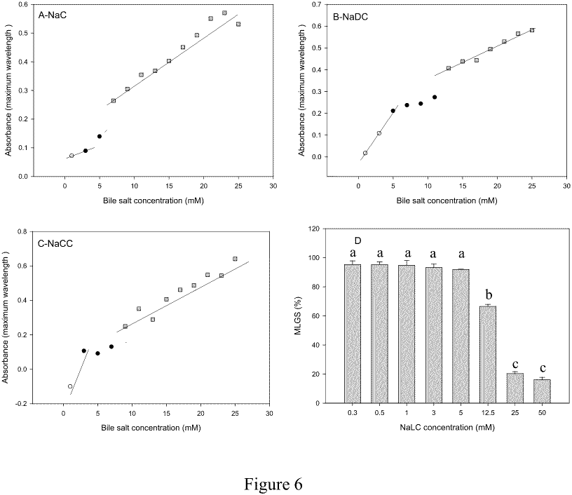

FIG. 6 includes four graphs showing critical micelle concentrations (CMC) of NaC (A), NaDC (B), and NaCC (C) in water and IRI activity represented as %MLGS of NaLC in PBS at varied concentrations (D). Different letters above the bars stand for a statistically significant difference (p < 0.05).

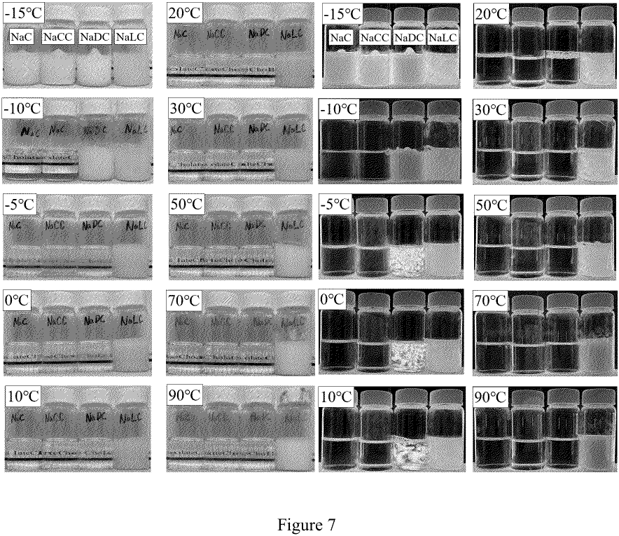

FIG. 7 shows color images of 25 mM NaC, NaDC, NaCC, and NaLC in PBS as a function of temperature. Ices were formed at -10° C. for NaDC, and -15° C. for NaC, NaCC and NaDC. The images on the right were obtained under polarized filters. Liquid crystals were observed for NaDC from -5° C. to 10° C., and for NaLC from -15° C. to 30° C.

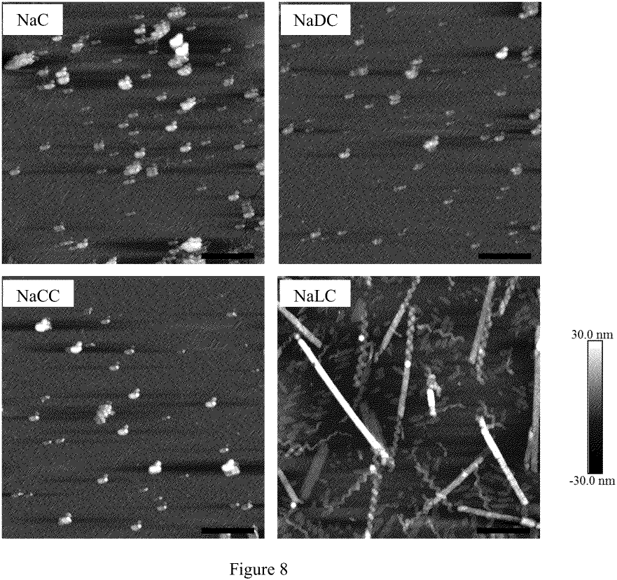

FIG. 8 shows color images for an atomic force microscopy (AFM) analysis of bile salts and a scale bar representing one µm. The color bars apply to all AFM images.

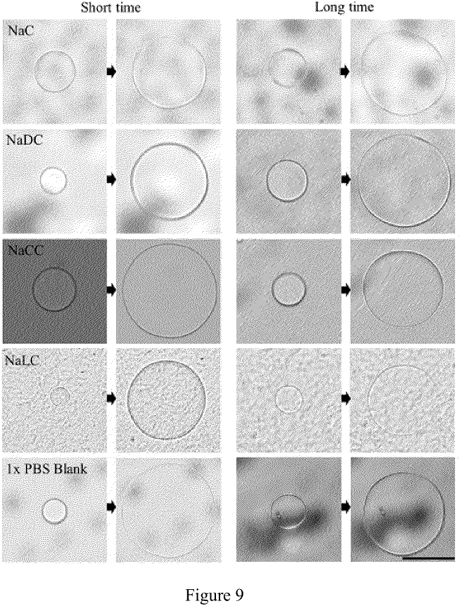

FIG. 9 shows color images for round isolated ice crystals after short or long exposure time. The images indicate no dynamic ice shaping for all bile salts at 50 mM. No thermal hysteresis was observed. The scale bars are 50 µm and all images share the same scale.

### DETAILED DESCRIPTION

The following detailed description will illustrate the general principles of the invention, examples of which are additionally illustrated in the accompanying drawings. In the drawings, like reference numbers indicate identical or functionally similar elements.

Except in the working examples, or where otherwise explicitly indicated, all numbers in this description indicating amounts, parts, percentages, ratios, and proportions of material, physical properties of material, and conditions of reaction are to be understood as modified by the word “about.” “About” as used herein means that a value is preferably +/-5% or more preferably +/- 2%. Percentages for concentrations are typically % by wt. For pH values, “about” means +/- 0.2.

In one embodiment, the disclosure is directed to a method of inhibiting ice recrystallization in a cryopreserved biological medium. The method includes the steps of cryopreserving a biological substrate including at least one of cryopreserved biological cells, cryopreserved biological tissue, and cryopreserved biological organs; and applying a bile salt to the cryopreserved biological substrate before and/or during cryopreservation of the biological substrate. The biological substrate can be selected from biological cells, biological tissue, biological organs, or a combination of the foregoing, and can be cryopreserved using any standard or known cryopreservation technique. The bile salt can be applied to the biological substrate either before or during cryopreservation of the biological substrate. The bile salt can inhibit the recrystallization of ice present on or in the cryopreserved biological substrate and can therefore stabilize the cryopreserved biological substrate.

Bile salts are biosurfactants synthesized in mammals to facilitate the digestion of lipids. As shown in FIG. 1, bile salts contain a steroid backbone with a carboxylate group on C24 and up to three hydroxyl groups on C3, C7, and C12. The steroid skeleton has a saucer shape with all hydroxyl groups pointed toward the concave surface. Thus, bile salts have a facial amphiphilicity, and might possess IRI activity based on the association between amphiphilicity and IRI. Exemplary bile salts include sodium cholate (NaC), which can be purchased from Thermo Fisher Scientific in Fair Lawn, NJ; sodium deoxycholate (NaDC) and sodium chenodeoxycholate (NaCC), which can be purchased from Sigma-Aldrich in St. Louis, MO; and sodium lithocholate (NaLC), which can be prepared by neutralizing lithocholic acid from Sigma-Aldrich with equimolar sodium hydroxide. Combinations of one or more bile salts can also be used to treat the biological substrate. Of the foregoing, NaLC has been discovered to be particularly suitable for the inhibition of ice recrystallization.

The bile salt can be applied to the biological substrate by first dissolving or dispersing the bile salt in a chemically stable solvent. One non-limiting example of a suitable solvent is phosphate-buffered saline (PBS), which is a pH-adjusted blend of ultrapure-grade phosphate buffers and saline solutions and, when diluted to a 1X working concentration, contains 137 mM NaCl, 2.7 mM KCl, 8 mM Na₂HPO₄, and 2mM KH₂PO₄. The bile salt can be dissolved or dispersed in the solvent at a concentration of about 10 mM to about 100 mM, suitable about 25 mM to about 100 mM. These concentrations have been found suitable when the solvent is PBS. Other concentration ranges may be found suitable when different solvents are used.

The bile salt may be applied to the biological substrate using any technique that results in an effective coating of the bile salt on the biological substrate. In one embodiment, the biological substrate can be immersed in a solution containing the bile salt to ensure a complete coating. If the biological substrate is a biological organ or tissue sample having a meaningful depth, it may be desirable to immerse the biological substrate in the bile salt solution for a time sufficient to completely soak the biological organ with the bile salt solution. If the biological substrate is a thin sample of tissue or cells, then a suitable coating may be obtained by spraying, dripping, or otherwise dropping the bile salt solution on a surface of the biological substrate. If the biological substrate is a collection of liquid cells such as blood, an effective amount of the bile salt can be dropped and mixed into the biological substrate, suitably employing minimal or no solvent.

The disclosure is also directed to a stabilized cryopreserved biological medium that can be prepared using any of the foregoing techniques. In one embodiment, the stabilized cryopreserved biological medium can include a cryopreserved biological substrate including at least one of biological cells, biological tissue, and biological organs, and a bile salt coated onto the cryopreserved biological substrate, wherein the bile salt inhibits ice recrystallization on the cryopreserved biological substrate. The bile salt can be selected from sodium cholate (NaC), sodium deoxycholate (NaDC), sodium chenodeoxycholate (NaCC), sodium lithocholate (NaLC), and combinations thereof. The bile salt can suitably be NaLC and can suitably be applied at an effective concentration in a solvent, for example PBS. The bile salt or bile salt solution can be applied to the biological substrate using any of the techniques described above.

### EXAMPLES

The following non-limiting Examples are provided to demonstrate the effectiveness of the inventions described herein. For these Examples, Sodium cholate (NaC) was purchased from Thermo Fisher Scientific (Fair Lawn, NJ). Sodium deoxycholate (NaDC) and sodium chenodeoxycholate (NaCC) were purchased from Sigma-Aldrich (St. Louis, MO). Sodium lithocholate (NaLC) was prepared by neutralizing lithocholic acid from Sigma-Aldrich with equimolar sodium hydroxide. Polyethylene glycol (PEG) (MW 8,000) was purchased from Alfa Aesar (Ward Hill, MA). Polyvinyl alcohol (PVA) (MW 89,000-98,000) was purchased from Sigma-Aldrich . 3-Aminopropyl triethoxysilane (APTES) was purchased from Thermo Fisher Scientific. Other common chemicals were purchased from Sigma Aldrich or Thermo Fisher Scientific. Deionized (DI) water was used for all experiments.

Ice recrystallization inhibition (IRI) activity of bile salts. NaC, NaDC, NaCC, and NaLC were tested for IRI activity at concentrations of 12.5, 25.0, 50.0, and 100 mM in 1x PBS using the “splat” assay test known and described in Knight, C. A.; Hallett, J.; Devries, A. L., “Solute effects on ice recrystallization: An assessment technique,” Cryobiology 1988, 25 (1), 55-60, which is incorporated herein by reference. 100 mM NaLC was not tested due to its gelation. A droplet of the sample was gently squeezed out of a syringe with a 21-gauge needle from Exelint, Redondo Beach, CA, and was dripped from 1.4 m above onto a microscope slide sitting on a metal block surrounded by dry ice. Upon hitting the slide surface, the droplet instantaneously froze into an ice wafer. The ice wafer was immediately transferred into the chamber of a cryostage system from Instec, Boulder, CO, for incubation. Pictures were taken after 30 min incubation at -8° C. by a BX51 polarized microscope from Olympus, Tokyo, Japan, equipped with a DP70 camera from Olympus. PEG was tested as a negative control at concentrations of 5, 10, 20, and 40 mg/mL in 1x PBS to match the mass concentrations (w/v) of bile salts. PVA was tested as a positive control at low concentrations, including 0.05, 0.10, 0.20, and 0.40 mg/mL in 1x PBS, because of its high IRI activity. The largest lengths of the five largest ice crystals in one picture were measured by Image J software from National Institutes of Health, Bethesda, MD. Each sample was performed in triplicate. Each replication had five pictures randomly selected, representing a total of 75 ice crystals for each sample. The percent mean largest grain size (%MLGS) was calculated by averaging three replications divided by the blank. Data are reported as the mean ± standard derivation of three replications. Representative ice wafer images are shown in FIG. 2. The %MLGS calculations are plotted in FIG. 3 against the concentrations of the bile acids and the controls.

As shown in FIG. 2, compared to the blank control of 1x PBS alone and the negative control of PEG in 1x PBS tested at 10, and 40 mg/mL, sodium lithocholate (NaLC) at 10 mg/mL (25 mM) had significantly smaller ice crystals. The ice crystal sizes with 10 mg/mL NaLC were comparable to those in the positive control of 1 mg/mL PVA, which has been reported as a potent ice recrystallization inhibitor. This result was quantified in FIG. 3 showing the percentages of mean largest grain size (%MLGS) as a function of concentration for the bile salts and the two controls. Sodium cholate (NaC) had a %MLGS similar to that of PEG at each comparable concentration and thus was not IRI active under test conditions. Sodium deoxycholate (NaDC) and sodium chenodeoxycholate (NaCC) had smaller %MLGS values than PEG at 40 mg/mL and can be grouped into weak ice recrystallization inhibitors (IRIs). NaLC was IRI active at a concentration around 10 mg/mL (25 mM) and can be considered a relatively potent IRI. On a molar concentration basis, NaLC is comparable to other reported small molecular IRIs, such as carbohydrate-based surfactants, which exhibit good IRI activity at a concentration of about 22 mM.

A subtle relationship between the hydrophobic moiety and the entire structure may influence the IRI activity drastically. For example, the overall hydrophobicity of bile salts increases in the order of NaC < NaDC = NaCC < NaLC, matching with the order of IRI activity increase. It seems that the hydrophobic interaction is responsible for the IRI activity of bile salts. However, on a monomer level, the increase of hydrophobicity in bile salts is caused by the decrease of hydrophilicity as the number of hydroxyl groups in steroid skeleton decreases, whereas the hydrophobic convex surface remains unchanged. Therefore, all bile salts monomers possess the same hydrophobic convex surface, suggesting the IRI activity was not associated with bile salts monomers. The potential link between the hydrophobicity and IRI may be is complicated by the self-assembly behavior of bile salts in aqueous solution. Another potent ice recrystallization inhibitor, PVA, is believed to interact with ice through hydrogen bonding by hydroxyl groups. Bile salts apparently do not interact with ice through hydrogen bonding because the IRI activity of bile salts increases as the number of hydroxyl groups decrease.

Ice growth kinetics of NaLC. The ice growth kinetics in the presence of NaLC at 12.5, 25, and 50 mM was determined at -8° C. in 1x PBS. Five pictures were taken every 5 min for a total time of 60 min. %MLGS at each time was calculated against its blank control at the same time. The plots of ice crystal length versus incubation time and %MLGS versus incubation time are shown in FIG. 4, A and B.

The ice growth kinetics in the presence of NaLC is demonstrated in FIG. 4. The NaLC at a concentration of 12.5 mM was IRI active but did not stop the ice growth completely. Higher concentrations of NaLC at 25.0 and 50.0 mM completely stopped the growth of ice crystals at an incubation temperature of -8° C. (FIG. 4-A). The %MLGS decreased with time because the size of ice crystals in 25 and 50 mM NaLC remained relatively constant but increased continuously in the blank control during incubation (FIG. 4-B).

Viscosity profiles, critical micelle concentration (CMC), and optical photos of bile salts. The critical micelle concentration of a colloid or surfactant is the concentration of surfactant above which micelles form, and any additional surfactant added to the system will form micelles. The viscosity profile of NaC, NaDC, NaCC, and NaLC at a concentration of 25 mM in 1x PBS were determined by an AR2000 rheometer from TA Instruments in New Castle, PA, with a 40 mm aluminum parallel plate at 25° C. The samples were measured from 0.1 to100 s⁻¹ shear rate after pre-shearing at 50 s⁻¹ for 30 seconds with or without an equilibrium time of 30 min. The CMCs were determined by a UV-vis spectroscopy method with slight modifications described in Reis, S.; Moutinho, C. G.; Matos, C.; de Castro, B.; Gameiro, P.; Lima, J. L., “Noninvasive methods to determine the critical micelle concentration of some bile acid salts,” Anal Biochem 2004, 334 (1), 117-26, which is incorporated herein by reference. NaC, NaDC, and NaCC were dissolved in water at concentrations from 1 to 25 mM. The absorbance spectra from 200 to 300 nm were collected by an Evolution 201 spectrometer from Thermo Scientific, Waltham, MA to find the peak absorbance. The CMC was determined from the sudden change of peak absorbance as concentration increases. The optical photos of bile salt in 1X PBS solutions were taken after incubation at each designed temperature for 20 minutes. The plots of viscosity versus shear rate, before and after equilibrium, are shown in FIG. 5, A and B. FIG. 6, A-D, shows plots of UV-spectroscopic absorbance versus bile salt concentration for three of the bile salts, and %MLGS versus bile salt concentration for NaLC. FIG. 7 shows optical photos of ice crystals of the bile salt solutions as a function of temperature.

It was noticed that gel was formed in 100 mM NaLC after sample preparation. Since high viscosity or gelation has been proposed as the IRI mechanism for ice cream stabilizers, the viscosity profiles of bile salt solutions were compared in FIG. 5 to examine a possible correlation between viscosity and IRI. The fresh-prepared NaLC had the highest viscosity among four bile salts (FIG. 5A). After a 30-min equilibrium, the viscosity of NaDC was increased significantly to a level similar to that of NaLC (FIG. 5B). However, only NaLC has a considerable IRI activity. Therefore, the IRI activities of bile salts were not correlated to viscosity or gel formation. This finding agrees with a previous report that IRI activities of carbohydrate-based hydrogelators were not associated with gel formation.

IRI activities of surfactants have been studied at concentrations far below the critical micelle concentration (CMC). Since the turbidity of NaLC solution interferes with the absorbance measurement, the critical micelle concentrations (CMCs) were determined only for NaC, NaDC, and NaCC by a UV-vis spectroscopical method. All three bile salts had two transition points on the absorbance-concentration plots (FIGS. 6 A, B, and C), indicating the presence of two micellization processes. The first and second CMCs were at 3-5 mM and 4-13 mM, respectively. Since the CMCs decrease with increased ionic strength, lower CMCs are expected for bile salts in PBS. Meanwhile, a decrease in the number of hydroxyl groups results in the decrease of CMCs and the NaLC is expected to have the lowest CMCs values. No IRI activity was observed for NaLC at concentrations close to or below its literature CMC value (FIG. 6D).

At temperatures below a Krafft point above CMC, ionic surfactants precipitate as hydrated solids or crystals. Referring to FIG. 7, the NaC, NaDC, and NaCC solutions were clear at temperatures from 90° C. to -15° C. The cloudy appearance of NaC and NaCC at -15° C. and NaDC at -10° C./-15° C. was caused by ice formation. The NaLC solution was turbid from 90° C. to -15° C. No precipitate was observed in any bile salt solution, indicating the absence of insoluble hydrated solids or crystals. Above CMC, a transition from isotropic micellar solution to anisotropic liquid crystals can be observed for bile salts. The transition depends on the temperature and occurs at concentrations above 20% for NaDC at room temperature. For 25 mM (around 1%) bile salts in this study, an anisotropic liquid crystal phase was observed for NaLC at temperatures from -15° C. to 30° C. and NaDC from -5° C. to 10° C. under crossed polarized filter, and no liquid crystal phase was observed for NaC and NaCC at all temperatures. Since NaCC is also a weak ice recrystallization inhibitor, the IRI activity of bile salts is thus independent of the liquid crystal formation.

Atomic force microscopy (AFM) analysis of bile salt solutions. The AFM procedure was followed as set forth in Schefer, L.; Adamcik, J.; Diener, M.; Mezzenga, R., “Supramolecular chiral self-assembly and supercoiling behavior of carrageenans at varying salt conditions,” Nanoscale 2015, 7 (39), 16182-16188, which is incorporated herein by reference. Briefly, 0.01% (v/v) APTES in water was incubated on a freshly peeled mica surface for 1 min. APTES solution was then washed away using water on a P6700 spin coater from Specialty Coating Systems Inc., Indianapolis, IN, at 2,000 rpm. About 200 µL of 25 mM sample was loaded on the mica surface and incubated for 30 seconds. Then the mica was rinsed with 1.0 mL water drop-wise and dried in a vacuum chamber at room temperature. All mica surfaces were observed by a Multimode VIII AFM from Bruker, Santa Barbara, USA, in ScanAsyst-Air mode. All images were flattened using Nanoscope Analysis software from Bruker, Santa Barbara, USA, before analyzing by an ImageJ instrument from National Institutes of Health, Bethesda, MD. FIG. 8 shows photomicrographs representing an atomic force microscopy (AFM) analysis of bile salts.

Bile salts demonstrate a complex self-assembly behavior driven by hydrophobic interaction and hydrogen bonding in aqueous solutions. For example, sodium deoxycholate self-assemblies into various structures from rod to sponge, vesicle, lamellae, and nanotube depending on the concentration, pH, temperature, ionic strength, and ionic composition. As show in in FIG. 8, the AFM observed a helical structure for NaLC but not with the other three bile salts. This helix has a width of 0.14 ± 0.01 µm, a turn of every 0.19 ± 0.04 µm, and a length of 1.72 ± 0.37 µm. In the two-step micellization model of bile salts, primary micelles are formed at lower concentrations, with the hydrophobic face of bile salts facing each other and buried inside the micelle. Secondary micelles are formed at higher concentrations with hydroxyl groups of primary micelles forming hydrogen bonds, leading to the formation of helical micelles with the hydrophobic surface in contact with the outer water molecules. It should be noted that the AFM was conducted with the dried sample. However, it is possible that helical or similar structures were also formed by other bile salts in solutions but were not detected by AFM. It is reasonable to hypothesize that the formation of secondary helical micelles or similar structures with exposed hydrophobic groups is responsible for the IRI activity of bile salts. However, this hypothesis should be confirmed by advanced analytical tools, such as cryogenic electron microscopy and small angle x-ray scattering analysis, which can characterize self-assembled bile salts’ structures in solutions.

Ice shaping and thermal hysteresis measurement. A droplet of immersion oil (2 µL) was loaded on a sapphire slide followed by injecting a 0.2 µL sample solution into it with a microliter needle and covering the oil droplet with a glass coverslip. After transferring into cryostage, the temperature was decreased to -30° C. at a rate of 30° C./min to freeze the sample. Then the temperature was slowly increased to approach the melting temperature until a single ice crystal was isolated under the microscope. For the short exposure time assay, the temperature was decreased at 0.1° C./min immediately once the single ice crystal was obtained. For the long exposure assay, a 30 min incubation time was applied to maintain the size of the single ice crystal before decreasing the temperature to grow it. Photos were taken before and after the growth. Thermal hysteresis was noted if there was any “burst growth” of ice crystals during the growth. FIG. 9 shows photomicrographs of isolated round ice crystals of the bile salts and a 1XPBS control after long and short exposure times.

Referring to FIG. 9, none of the bile salts exhibited dynamic ice shaping (DIS) after short or prolonged exposure. None of them exhibited any measurable thermal hysteresis (TH). Generally, the presence of DIS and TH has been associated with an ice-binding behavior. These results suggest that bile salts do not bind to ice. The lack of ice-binding ability is not rare for IRI active materials and is apparently not necessary for IRI activity.

### Conclusion

In conclusion, this disclosure presents the first example of a small biological molecule with IRI activity. Among all bile salts tested, the most hydrophobic sodium lithocholate (NaLC) is the most potent ice recrystallization inhibitor that can block the growth of ice crystals at 25 mM in PBS. The IRI activities do not correlate with viscosity or gel formation. No IRI activity was observed below the critical micelle concentration. The IRI activity was independent of the formation of liquid crystal. In addition, a helical structure was observed with NaLC by AFM in a dry state. However, it is difficult to conclude that IRI activity is associated with helical structure without fully characterizing bile salt structure in solution. Nevertheless, the present discovery indicates that small biological molecules can be effective new materials for ice recrystallization inhibition.

The embodiments described herein are not limited in their application or use to the details of construction and arrangement of parts and steps illustrated in the drawings and description. Features of the illustrative embodiments and variants may be implemented or incorporated in other embodiments, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention. Having described the invention in detail and by reference to preferred embodiments thereof, it will be apparent that modifications and variations are possible without departing from the scope of the invention which is defined in the appended claims.

What is claimed is:

1. A method of inhibiting ice recrystallization in a cryopreserved biological medium, comprising the steps of:
cryopreserving a biological substrate including at least one of cryopreserved biological cells, cryopreserved biological tissue, and cryopreserved biological organs; and
applying a bile salt to the cryopreserved biological substrate before and/or during cryopreservation of the biological substrate.

2. The method of claim 1, wherein the bile salt is selected from the group consisting of sodium cholate (NaC), sodium deoxycholate (NaDC), sodium chenodeoxycholate (NaCC), sodium lithocholate (NaLC), and combinations thereof.

3. The method of claim 1, wherein the bile salt is dissolved in a solvent to form a solution and the solution is applied to the cryopreserved biological substrate.

4. The method of claim 3, where the solvent comprises phosphate-buffered saline (PBS).

5. The method of claim 4, wherein the solution comprises the bile salt at a concentration of about 10 mM to about 100 mM.

6. The method of claim 1, wherein the bile salt comprises NaLC.

7. The method of claim 6, wherein the solution comprises the NaLC at a concentration of about 10 mM to about 100 mM.

8. The method of claim 1, wherein the bile salt is applied to the biological substrate before cryopreservation of the biological substrate.

9. The method of claim 1, wherein the bile salt is applied to the biological substrate during cryopreservation of the biological substrate.

10. The method of claim 1, wherein the bile salt is applied to the biological substrate by immersing the biological substrate in a solution containing the bile salt.

11. The method of claim 1, wherein the bile salt is applied to the biological substrate by spraying or dripping a solution containing the bile salt onto the biological substrate.

12. A method of inhibiting ice recrystallization in a cryopreserved biological medium, comprising the steps of:
cryopreserving a biological substrate including at least one of cryopreserved biological cells, cryopreserved biological tissue, and cryopreserved biological organs; and
applying a solution containing a bile salt to the cryopreserved biological substrate before and/or during cryopreservation of the biological substrate;
wherein the solution includes about 25 mM to about 100 mM of the bile salt in a solvent.

13. The method of claim 12, wherein the bile salt is selected from the group consisting of sodium cholate (NaC), sodium deoxycholate (NaDC), sodium chenodeoxycholate (NaCC), sodium lithocholate (NaLC), and combinations thereof.

14. The method of claim 12, wherein the bile salt comprises NaLC.

15. The method of claim 12, wherein the solvent comprises phosphate-buffered saline (PBS).

16. A stabilized cryopreserved biological medium, comprising:
a cryopreserved biological substrate including at least one of biological cells, biological tissue, and biological organs; and
a bile salt coated onto the cryopreserved biological substrate;
wherein the bile salt inhibits ice recrystallization on the cryopreserved biological substrate.

17. The stabilized cryopreserved biological medium of claim 16, wherein the bile salt is selected from the group consisting of sodium cholate (NaC), sodium deoxycholate (NaDC), sodium chenodeoxycholate (NaCC), sodium lithocholate (NaLC), and combinations thereof.

18. The stabilized cryopreserved biological medium of claim 16, wherein the bile salt comprises NaLC.

19. The stabilized cryopreserved biological medium of claim 16, wherein the cryopreserved biological substrate comprises biological cells.

20. The stabilized cryopreserved biological medium of claim 16, wherein the cryopreserved biological substrate comprises biological tissue.

21. The stabilized cryopreserved biological medium of claim 16, wherein the cryopreserved biological substrate comprises a biological organ.
